(19) United States
(12) Patent Application Publication
(10) Pub. No.: US 2008/0147379 A1
(43) Pub. Date: Jun. 19, 2008

(54) METHOD AND APPARATUS FOR IMPROVING CALL QUALITY IN PORTABLE TERMINAL

(75) Inventor: In-Ho KIM, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/959,607

(22) Filed: Dec. 19, 2007

(30) Foreign Application Priority Data
Dec. 19, 2006 (KR) 2006-0129882

(51) Int. Cl. G06F 17/20

(52) U.S. Cl. 704/8

(57) ABSTRACT

A method and an apparatus for improving a call quality in a portable terminal. The method includes selecting one of a plurality of languages by a user when a received language setup menu is selected during a communication of a user with a caller; checking a volume of the selected language according to a frequency of the selected language; and applying the checked volume of the selected language to a voice signal received from a terminal of the caller according to a frequency of the voice signal and outputting the voice signal to which the checked volume has been applied.

### PRIORITY

This application claims priority under 35 U.S.C. § 119 to an application filed in the Korean Intellectual Property Office on Dec. 19, 2006 and assigned Serial No. 2006-129882, the contents of which are incorporated herein by reference.

### BACKGROUND OF THE INVENTION

1. Field of the Invention

The present invention generally relates to a method and an apparatus for improving a call quality in a portable terminal, and in particular, to a method and an apparatus for improving quality of a received voice signal in consideration of a characteristic of a language used by a caller.

2. Description of the Related Art

The use of portable terminals has experienced dramatic growth. Portable terminals have also been exported in increasing numbers to foreign countries, such as English and American cultural areas, Chinese cultural areas, etc., due, in part, to their portability convenience. Therefore, service providers (or manufacturers) of portable terminals have briskly conducted developmental research on terminals having more convenient functions in order to secure many users and increase exports.

For example, research on portable terminals has focused on improving quality of voice signals, which are received and transmitted during voice calls, in consideration of item characteristics, instrumental structures, etc., of receivers (or speakers). In other words, research on variations of sensitivity of speakers according to a frequency of user voice have been conducted in order to accurately output received voice signals. Receivers, as used herein, refer to speakers which are used for voice calls with lower powers than general speakers. Thus, receivers will be referred to as speakers.

However, research on variations of sensitivity of speakers generally concentrate on only users of portable terminal developing countries, i.e., only one language, in development phases. Accordingly, a conventional portable terminal neglects various lingual characteristics but aims at one language in order to set receive sensitivity according to a frequency. Thus, if a language of a caller is different from the language, a received voice signal is not accurately output due to a frequency difference resulting from characteristics of the languages.

### SUMMARY OF THE INVENTION

The present invention substantially solves at least the above problems and/or disadvantages and provides at least the advantages below. Accordingly, an aspect of the present invention is to provide a method and an apparatus for improving a call quality in a portable terminal.

Another aspect of the present invention is to provide a method and an apparatus for improving a call quality in consideration of a characteristic of a language of a caller in a portable terminal.

A further aspect of the present invention is to provide a method and an apparatus for varying receive sensitivity of a speaker according to a frequency of a language of a caller to improve a quality of a received voice signal.

The above aspects are achieved by providing a point-to-point emulation apparatus and method in a broadband wireless communication system.

According to an aspect of the present invention, there is provided a method of improving a call quality in a portable terminal, the method including selecting one of a plurality of languages by a user when a received language setup menu is selected during a communication of a user with a caller; checking a volume of the selected language according to a frequency of the selected language; and applying the checked volume of the selected language to a voice signal received from a terminal of the caller according to a frequency of the voice signal and outputting the voice signal.

According to another aspect of the present invention, there is provided an apparatus for improving a call quality in a portable terminal, the apparatus including a storage unit storing volumes of a plurality of languages which vary with frequencies; a communication module receiving a voice signal from a terminal of a caller; a controller checking one of the plurality of languages selected by a user and a volume of the selected language which varies according to a frequency when a received language setup menu is selected during a communication with the terminal; and a voice processor applying the checked volume to the voice signal received from the communication module according to the frequency of the voice signal.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a portable terminal according to the present invention;

FIG. 2 is a flowchart of a process of improving a call quality according to a language of a user in a portable terminal according to the present invention; and

FIGS. 3A through 3C illustrate curves of characteristics of languages in a portable terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a method and an apparatus for varying a volume of a received voice signal according to a frequency characteristic of a language used by a caller to improve a quality of the received voice signal.

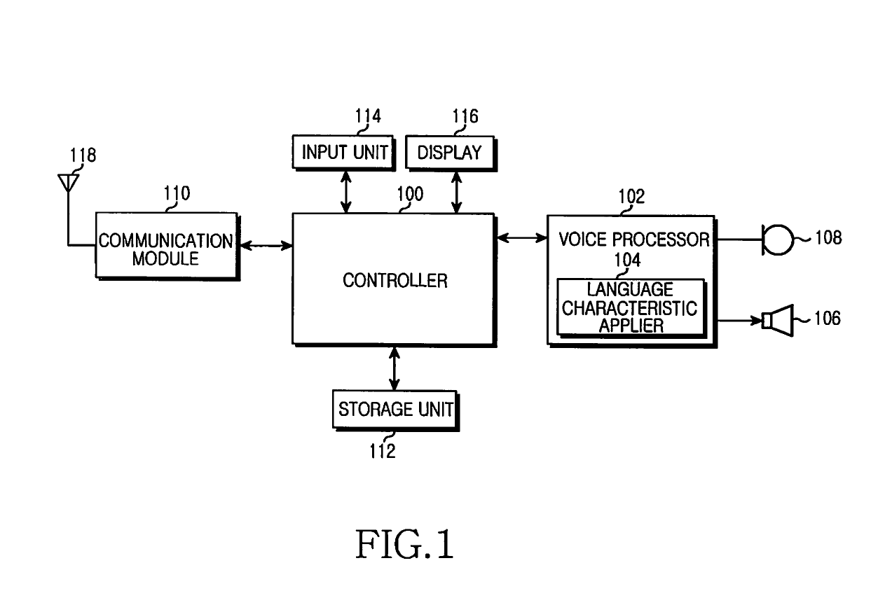

FIG. 1 shows a portable terminal according to the present invention. The portable terminal of FIG. 1 includes a controller 100, a voice processor 102 having a language characteristic applier 104, a speaker 106, a microphone 108, a communication module 110, a storage unit 112, an input unit 114, a display 116, and an antenna 118.

The controller 100 processes and controls an overall operation of the portable terminal, e.g., operations for performing voice and data communications. In particular, according to the present invention, if a received language setup menu is selected by a user, the controller 100 may control the display 116 to display a language list so as to process and control a function of displaying a window on which a received language is to be set. If a signal for a language selected by the user is input from the input unit 114, the controller 100 may read a language characteristic curve corresponding to the language from the storage unit 112 and output the language characteristic curve to the language characteristic applier 104 of the voice processor 102. The language characteristic curve indicates a volume of a voice signal, i.e., an output level of the voice signal, which varies according to variations of a frequency, and shows different forms according to language.

The voice processor 102 is also referred to as a Coder-Decoder (CODEC) and inputs and outputs the voice signal through the microphone 108 and the speaker 106 which are connected to the voice processor 102. For example, the voice processor 102 converts a digital voice signal provided from the controller 100 into an analog voice signal, transmits the analog voice signal through the speaker 106, converts a voice signal applied from the microphone 108 into a digital voice signal, and provides the digital voice signal to the controller 100. In particular, according to the present invention, the voice processor 102 may include the language characteristic applier 104 to apply a language characteristic curve, which considers a frequency characteristic of a language of a caller, to a voice signal received from a terminal of the caller and then output the voice signal to the speaker 106.

The language characteristic applier 104 receives the language characteristic curve of the language selected by the user from the controller 100, applies the language characteristic curve to the voice signal received from the terminal of the caller, varies an output level of the voice signal according to a frequency, and outputs the voice signal to the speaker 106.

The communication module 110 transmits and/or receives a Radio Frequency (RF) signal of data which is input and output through the antenna 118. For example, the communication module 110 may upconvert a baseband signal to be transmitted to transform the baseband signal into an RF signal and transmit the RF signal through the antenna 118. Alternatively, the communication module 110 may downconvert an RF signal received from the antenna 118 to transform the RF signal into a baseband signal so as to recover data.

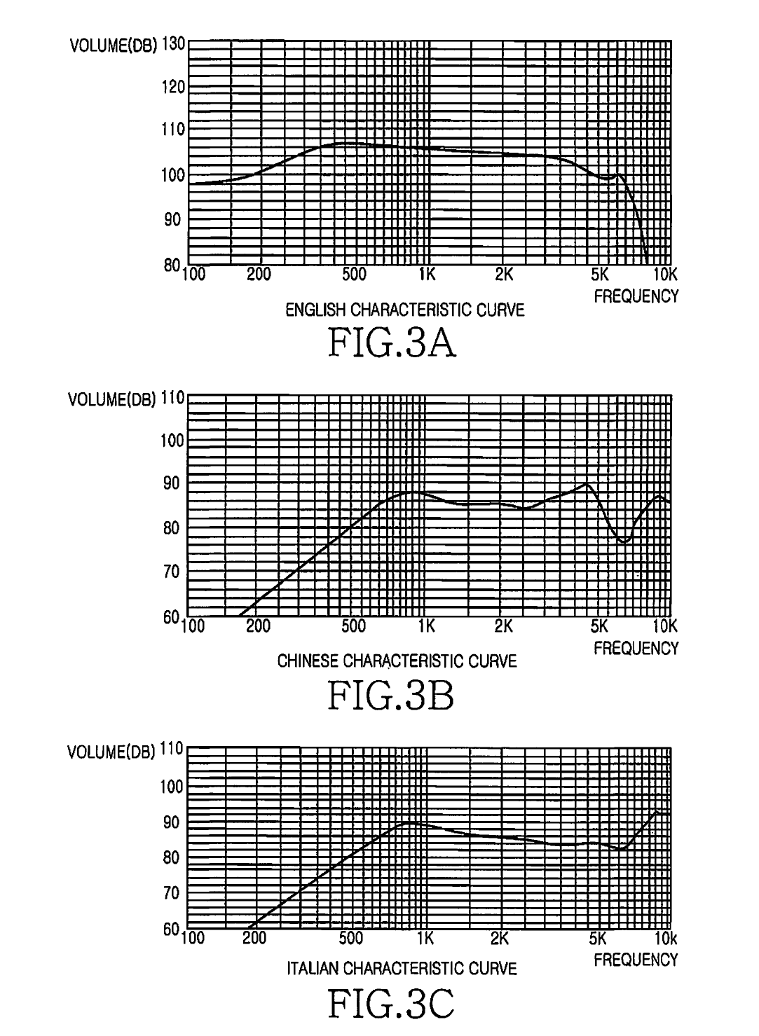

The storage unit 112 stores various types of programs and micro-codes necessary for the overall operation of the portable terminal. According to the present invention, the storage unit 112 may store language characteristic curves of languages which indicate volumes of voice signals varying according to frequencies. For example, the storage unit 112 stores language characteristic curves which indicate characteristics of English, Chinese, and Italian, as shown in FIG. 3.

The input unit 114 includes numeral keys, character keys, and a plurality of function keys to provide the controller 100 with data corresponding to a key pressed by the user. In particular, according to the present invention, the input unit 114 may receive a received language of received languages, which are displayed on the display 116, from the user and provide the received language to the controller 100.

The display 116 displays state information, limited numerals and characters, a plurality of moving pictures, a plurality of still pictures, etc., which are generated during the operation of the portable terminal. In particular, according to the present invention, the display 116 may be controlled by the controller 100 to display the window on which the received language is to be set.

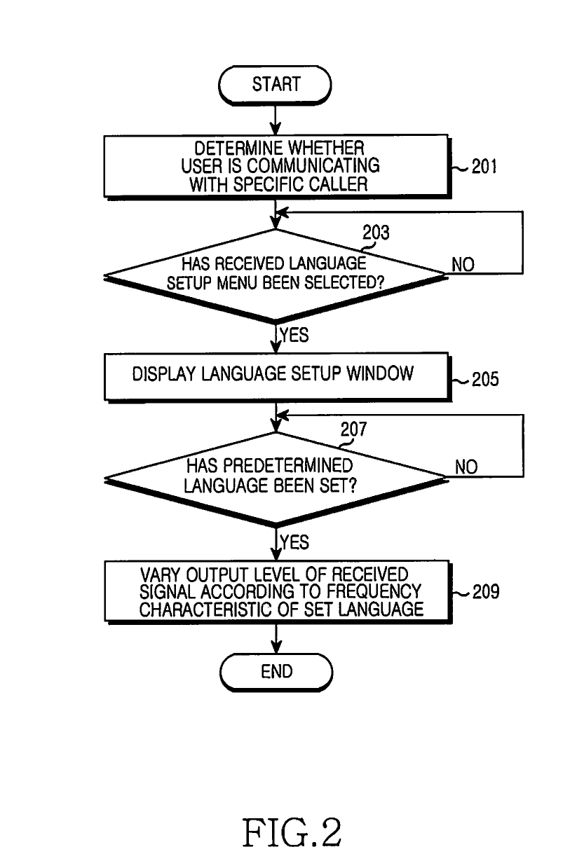

FIG. 2 shows a process of improving a call quality according to a language of a user in a portable terminal according to the present invention.

In step 201 of FIG. 2, the portable terminal determines whether a user is communicating with a specific caller. If it is determined in step 201 that the user is communicating with the specific caller, the portable terminal proceeds to step 203 to determine whether a received language setup menu has been selected by the user. In other words, the portable terminal determines whether a menu for setting a language used by the specific caller has been selected, in order to accurately output a voice signal received from a terminal of the specific caller.

If it is determined in step 203 that the received language setup menu has been selected by the user, the portable terminal proceeds to step 205 to display a language list on the display 116 to display a window on which a language is to be set. For example, the portable terminal may display a language list “1: English, 2: Chinese, and 3: Italian” on the display 116 to request the user to set a specific language. In step 207, the portable terminal determines whether a language of the displayed language list has been set by the user.

If it is determined in step 207 that the language has been set by the user, the portable terminal proceeds to step 209 to check a language characteristic curve indicating a characteristic of the language set by the user, adjust a volume of the voice signal received from the terminal of the specific caller, i.e., an output level of the voice signal, according to a frequency of the voice signal using the language characteristic curve, and output the voice signal to the speaker 106.

For example, if the user sets English as a received language, the portable terminal may determine that the voice signal received from the terminal of the specific caller is English, apply a language characteristic curve considering a characteristic of English as shown in FIG. 3A to the voice signal, adjust the output level of the voice signal according to the frequency of the voice signal, and output the voice signal to the speaker 106.

The portable terminal then ends the present process.

In accordance with the present invention as described above, a portable terminal can pre-store a language characteristic curve considering a characteristic of a language, apply the language characteristic curve to a voice signal received from a terminal of a caller according to a language used by the caller, and vary an output volume of the voice signal according to a frequency of the voice signal. Thus, the portable terminal can further accurately provide a user with voices of callers using languages having various characteristics. As a result, a call quality can be improved.

Alternate embodiments of the present invention may also include computer readable codes on a computer readable medium. A computer readable medium may include any data storage device that can store data that can be read by a computer system. Examples of a computer readable medium include, for example, magnetic storage media (such as ROM, floppy disks, and hard disks, among others), optical recording media (such as CD-ROMs or DVDs), and storage mechanisms such as carrier waves (such as transmission through the Internet). A computer readable medium can also be distributed over network coupled computer systems so computer readable code is stored and executed in a distributed fashion. Also, functional programs, codes, and code segments for accomplishing the present invention may be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of improving a call quality in a portable terminal, the method comprising:
selecting one of a plurality of languages when a received language setup menu is selected during a communication of a user with a caller;
checking a volume of the selected language according to a frequency of the selected language; and
applying the checked volume of the selected language to a voice signal received from a terminal of the caller according to a frequency of the voice signal and outputting the voice signal.

2. The method of claim 1, wherein the volume of the selected language is represented with a curve which indicates an output level of the voice signal depending on the frequency of the voice signal.

3. The method of claim 1, wherein the portable terminal pre-stores volumes of the plurality of languages which vary with frequencies.

4. An apparatus for improving a call quality in a portable terminal, the apparatus comprising:
a storage unit storing volumes of a plurality of languages which vary with frequencies;
a communication module receiving a voice signal from a terminal of a caller;
a controller checking one of the plurality of languages selected by a user and a volume of the selected language which varies according to a frequency when a received language setup menu is selected during a communication with the terminal; and
a voice processor applying the checked volume to the voice signal received from the communication module according to the frequency of the voice signal.

5. The apparatus of claim 4, wherein the volume of the selected language is represented with a curve which indicates an output level of the voice signal depending on the frequency of the voice signal.

6. The apparatus of claim 4, further comprising a speaker outputting the voice signal to which the volume is applied by the voice processor.

7. The apparatus of claim 4, further comprising:
a display displaying a list of the plurality of languages when the received language setup menu is selected during the communication with the terminal; and
an input unit receiving the one language of the plurality of languages from the user.

8. A method of improving a call quality in a portable terminal, the method comprising:
checking a volume of a selected language according to a frequency of the selected language; and
applying the checked volume to a voice signal received from a terminal of a caller and outputting the voice signal to which the checked volume has been applied.

9. The method of claim 8, wherein the volume of the selected language is represented with a curve which indicates an output level of the voice signal depending on the frequency of the voice signal.

10. A portable terminal for improving a call quality, the portable terminal comprising:
a storage unit storing volumes of a plurality of languages which vary according to frequencies;
a controller checking a volume of one of the plurality of languages selected by a user; and
a voice processor applying the checked volume to a voice signal received from a terminal of a caller.

11. The portable terminal of claim 10, wherein the volume of the selected language is represented with a curve which indicates an output level of the voice signal depending on the frequency of the voice signal.

12. The portable terminal of claim 10, further comprising a speaker outputting the voice signal to which the volume has been applied by the voice processor.

13. The portable terminal of claim 10, further comprising:
a display displaying a list of the plurality of languages necessary for setting a received language during a communication; and
an input unit receiving the one language of the plurality of languages from the user.

14. A portable terminal for improving a call quality comprising:
means for checking a volume of a selected language according to a frequency of the selected language; and
means for applying the checked volume to a voice signal received from a terminal of a caller and outputting the voice signal to which the checked volume has been applied.

15. The portable terminal of claim 14, further comprising:
means for selecting one of a plurality of languages when a received language setup menu is selected during a communication of a user with a caller.
